(19) United States
(12) Patent Application Publication
(10) Pub. No.: US 2026/0353187 A1
(43) Pub. Date: Nov. 5, 2026

(54) CLOUDRIC: REAL-TIME AND ENERGY-EFFICIENT CONTROL OF VRAN RESOURCES IN SHARED O-RAN CLOUDS

(71) Applicant: NEC Laboratories Europe GmbH, Heidelberg (DE)

(72) Inventors: Andres GARCIA-SAAVEDRA, Heidelberg (DE); Xi LI, Heidelberg (DE); Linghang FAN, Heidelberg (DE)

(21) Appl. No.: 19/102,890

(22) PCT Filed: Dec. 6, 2022
(86) PCT No.: PCT/EP2022/084667

§ 371 Date: Feb. 11, 2025

(30) Foreign Application Priority Data
Aug. 19, 2022 (EP) 22191344.5

(51) Int. Cl. H04W 28/08; H04L 47/19; H04L 47/283; H04L 47/56; H04L 47/625; H04W 28/02; H04W 28/16

(52) U.S. Cl. CPC H04W 28/0917; H04L 47/19; H04L 47/283; H04L 47/56; H04L 47/6255; H04W 28/0268; H04W 28/0975; H04W 28/16

(57) ABSTRACT

A method of assigning hardware accelerator (HA) resources to a scheduled grant for processing a transport block (TB) includes assigning a logical processing unit (LPU) of a plurality of LPUs to the scheduled grant. Each LPU of the plurality of LPUs represents a respective HA, and the assigning assigns the LPU based on at least one of a respective latency predicted for each HA to complete processing of the TB, or a respective energy consumption predicted for each HA to complete processing of the TB.

### CROSS REFERENCE TO RELATED APPLICATIONS

This application is a U.S. National Phase application under 35 U.S.C. § 371 of International Application No. PCT/EP2022/084667, filed on Dec. 6, 2022, and claims benefit to European Patent Application No. 22191344.5, filed on Aug. 19, 2022. The International Application was published in English on Feb. 22, 2024 as WO 2024/037730 A1 under PCT Article 21(2).

### FIELD

The present disclosure relates to a communication system. The disclosure has particular but not exclusive relevance to wireless communication systems and devices thereof operating according to the 3rd Generation Partnership Project (3GPP) standards or equivalents or derivatives thereof. The disclosure has particular although not exclusive relevance to systems using real-time and energy-efficient control of virtualized radio access network (vRAN) resources.

### BACKGROUND

The O-RAN Alliance (O-RAN) is a group that defines specifications for open radio access networks (Open RANs). The Open RAN architecture is based on a disaggregated approach to deploying RANs, that is built on cloud native principles, and represents an evolution of the Next Generation RAN (NG-RAN) architecture.

O-RAN has proposed a cloud architecture to host O-RAN compliant Network Functions (NFs) such as Distributed Units (DUs). Therein, O-RAN's Acceleration Abstraction Layer (AAL) provides a common interface for NFs such as DUs to access Hardware Accelerators (HAs). This abstraction allows developers to decouple their software designs from the specifics of the accelerators.

To this end, O-RAN has introduced the concept of an AAL Logical Processing Unit (AAL-LPU) as shown in FIG. 1. An AAL-LPU is a logical representation of the HA resources within a specific NF (e.g., a DU). This representation supports HAs that provide multiple processing units, subsystems, or hard partitions of the HA resources, each represented as an AAL-LPU. Although a HA may support multiple AAL-LPUs, an AAL-LPU is always associated to a single HA, as depicted in FIG. 3. Then, AAL Queues are used by NFs to share AAL-LPU resources. In addition, an AAL-LPU may be associated with one or multiple AAL Profiles, which specify the functions that can be offloaded to a HA. Forward error correction (FEC) low-density parity-check (LDPC) decoding tasks are focused on in the following description.

A key problem with this approach is that load balancing cannot be implemented efficiently because NFs can greedily select HAs, e.g., in platforms with heterogeneous accelerating resources, NFs may overload the fastest HA, which converges to poor performance overall. In this way, despite providing appropriate abstractions, O-RAN's AAL alone cannot efficiently broker access to shared infrastructure because centralized coordination of acceleration resources is not supported and neither can impose radio scheduling policies to associated DUs.

In earlier work, three extensions to the O-RAN open cloud (O-Cloud) architecture were proposed, as illustrated in FIG. 2. These extensions integrate seamlessly into the standard O-RAN O-Cloud architecture and add three key enhancements:
A function called real-time RAN intelligent controller (or “Real-Time RIC (RT-RIC)”), which receives temporary grants issued by DUs and returns final grants: a modification (or not) of temporary grants that can maximize wireless throughput and the AAL can meet the deadline to process the corresponding Transport Blocks (TBs).
A function called “AAL Broker”, with two sub-components:
   AAL Broker Control Plane (AAL-B-CP): which is responsible for assigning LPUs to final grants such that processing deadlines are met with the minimum amount of energy cost.
   AAL Broker User Plane (AAL-B-UP): which acts as a proxy between O-RAN NFs (O-DUs, in this case) and an O-RAN AAL. From the perspective of the NFs, the AAL-B-UP behaves as a virtual AAL LPU that provides all the AAL Profiles supported by all the HAs in the system. From the perspective of each O-RAN AAL LPU, the AAL-B-UP simply plays the role of an NF. The AAL-B-UP is responsible for routing TBs granted to UEs to the AAL Queue corresponding to the LPU assigned by the AAL-B-CP.
An interface for real-time communication between the Broker, RT-RIC and O-DUs, which is referred to as the ‘E3’ interface.

Given the real-time nature of interface E3, it is expected that the RT-RIC, DU instances and AAL Broker to be deployed in the same physical infrastructure, such as an edge data center.

This approach has three advantages:
1. By decoupling AAL-B-CP and AAL-B-UP, overhead in the data plane can be minimized;
2. By centralizing the allocation of computing resources, the load can be better balanced to meet a desired goal; and
3. By influencing the radio scheduler of DUs, deadlines can be guaranteed to be met (e.g., bounding the allocation of radio resources when AAL Queues are congested).

A remaining challenge, however, is the design of an efficient methodology that uses the architecture of FIG. 2 to optimize the performance of the RAN.

In summary, therefore, a problem exists that load balancing cannot be implemented efficiently with O-RAN standard because NFs can only greedily select HAs, without information about the queues associated with other NFs sharing the same HAs. This is highly inefficient because, in platforms with heterogeneous accelerating resources, NFs may overload the fastest HA, which converges to poor performance and consumes more energy overall. While the earlier work provided a number of advantages, it did not provide a mechanism that exploited the AAL-Broker and a RT-RIC in a manner that at least contributed to maximizing throughput and minimizing energy consumption.

### SUMMARY

In an embodiment, the present disclosure provides a method of assigning hardware accelerator (HA) resources to a scheduled grant for processing a transport block (TB). The method includes assigning a logical processing unit (LPU) of a plurality of LPUs to the scheduled grant, where each LPU of the plurality of LPUs represents a respective HA, and where the assigning assigns the LPU based on at least one of a respective latency predicted for each HA to complete processing of the TB, or a respective energy consumption predicted for each HA to complete processing of the TB.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates an O-RAN Acceleration Abstraction Layer (AAL);

FIG. 2 schematically illustrates an O-Cloud architecture;

FIG. 3 schematically illustrates a cloud RIC design and workflow;

FIG. 4 is an illustration of an LPU Allocator;

FIGS. 5(a) and 5(b) are, together, a message sequence diagram for the workflow shown in FIG. 3;

FIG. 6 schematically illustrates an O-RAN architecture to which the above aspects are applicable;

FIG. 7 is a block diagram illustrating the main components of a UE;

FIG. 8 is a block diagram illustrating the main virtual components of an exemplary v(R)AN node; and

FIG. 9 is a block diagram illustrating the main virtual components of a core network node.

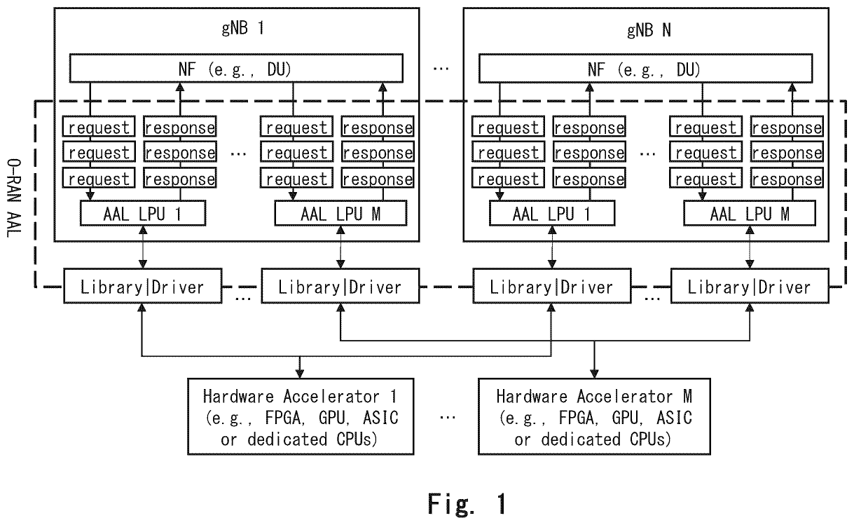

### DETAILED DESCRIPTION

The project leading to this application has received funding from the European Union's Horizon 2020 research and innovation programme under grant agreement No 101017109.

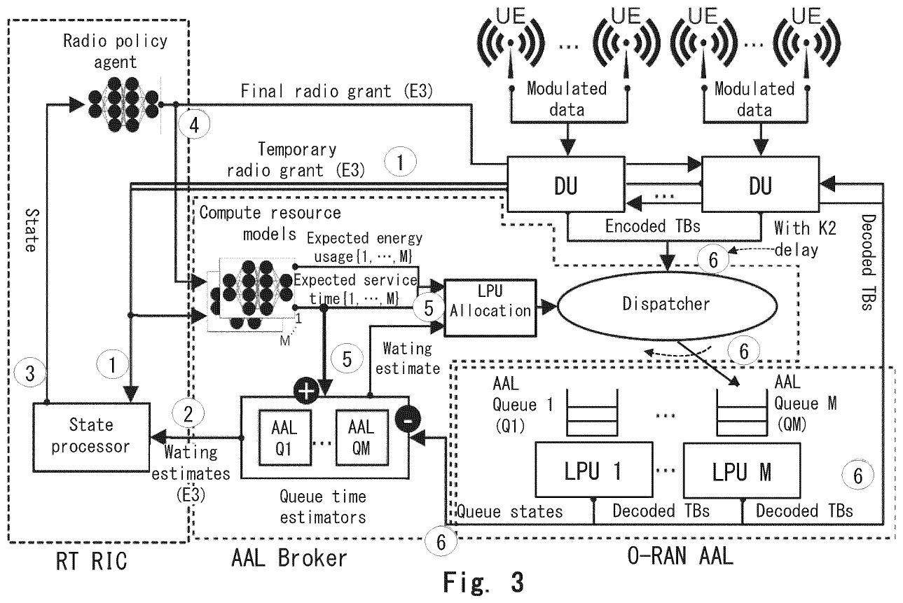

FIG. 3 illustrates a cloud RAN intelligent controller (RIC) design and workflow.

For the purposes of explanation, a system is considered that comprises a trivial number of virtual DU instances that share the same O-Cloud infrastructure to offload FEC decoding tasks.

An O-Cloud is also considered that comprises a set of M, potentially heterogeneous, HAs.

DUs allocate radio resources to associated UEs by issuing a grant following their own MAC-layer scheduling procedures but, beneficially, obeying a simple policy, referred to herein as CloudRIC, as will be explained later.

The resulting Transport Block (TB) sent by the user (UE) shall be processed (decoded) by the AAL within a time constraint D; otherwise, the TB is discarded.

A goal here is to minimize energy consumption of the system over the long run subject to satisfying the time constraint D deadline for every scheduled TB.

A key consideration for the design of real-time RAN control mechanisms, often ignored in the literature, is the latency overhead they introduce, which adds up to the overall processing latency for TBs. Hence, it is beneficial for a system to be designed that expedites decisions, which precludes the use of complex optimization approaches or large machine-learning models.

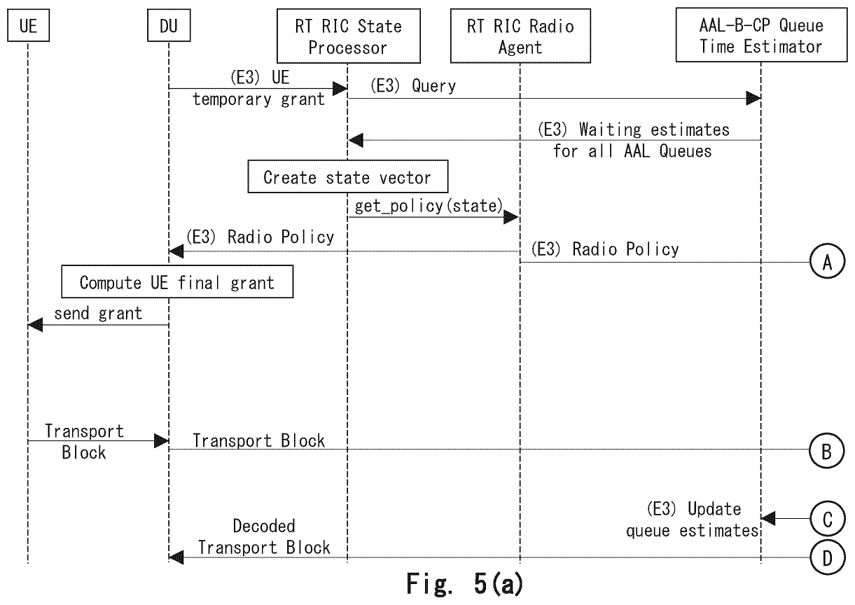

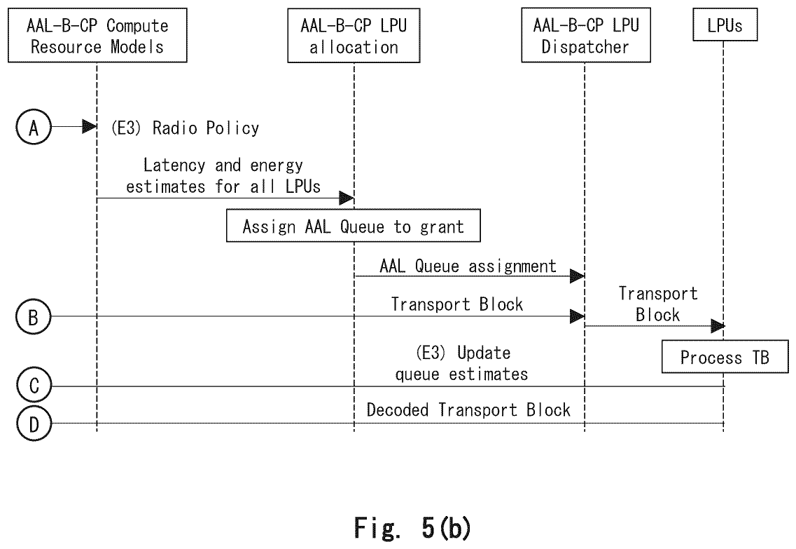

A detailed illustration of one particularly beneficial CloudRIC design is depicted in FIG. 3. An exemplary implementation of the workflow shown in FIG. 3 is illustrated in FIGS. 5a and 5b which, together, illustrate a possible sequence of messages between various entities of the system for implementing the workflow. The key of this CloudRIC design is its reliance on distributed and ultra-light neural network models that, in coordination, do the job efficiently. The main workflow of this design is as follows:

### Step (1)

Every temporary grant arriving at the RT-RIC g̅⁽ⁱ⁾, i∈{1, 2, . . . } includes its bandwidth b̅⁽ⁱ⁾ (number of RBs), the selected modulation and coding scheme (MCS) m⁽ⁱ⁾, the UE's signal to noise ratio (SNR) q⁽ⁱ⁾, the corresponding TB size (bits) t̅⁽ⁱ⁾, and a priority p⁽ⁱ⁾, i.e.,

$${\overline{g}}^{( i )} := [ {q}^{( i )} , {m}^{( i )} , {\overline{b}}^{( i )} , {\overline{t}}^{( i )} , {p}^{( i )} ] .$$

The top bar ⋅̅ is used here to indicate that the corresponding element ⋅ is temporary.

### Step (2)

Upon receiving the temporary grant g̅⁽ⁱ⁾, the RT-RIC's state processor collects state information from the AAL-B-CP about each AAL Queue

$${Q}_{n}^{( i )} ,$$

∀n∈ [symbol] :={L₁, . . . , L_{M}}, where Lₖ is the k^{th} LPU. This information consists of estimates (predictions) of the waiting time at each AAL Queue denoted as

$${\hat{w}}^{( i )} := [ {\hat{w}}_{1}^{( i )} , … , {\hat{w}}_{M}^{( i )} ]$$

The top hat \hat{⋅} is used here to indicate that the corresponding element ⋅ is a prediction.

To estimate the waiting time

$${\hat{w}}_{n}^{( i )} ,$$

∀n∈ [symbol] , the AAL-B-CP aggregates the expected processing time

$${\hat{d}}_{n}^{( k )}$$

of every grant g^{(k)} in queue

$${Q}_{n}^{( i )}$$

and the expected leftover processing time of the TB associated with grant g^{(s)} that is being processed in the LPU at the time, i.e.,

$${\hat{d}}_{n}^{( s )} - {Δ}_{n}^{( s )} ,$$

where

$${Δ}_{n}^{( s )}$$

is the (real) time the TB has been held by the LPU so far (s<k<i).

A beneficial approach for calculating the processing time d̅ₙ is detailed in step (5).

### Step (3)

The state processor consolidates all the above information into a single feature vector x⁽ⁱ⁾,

x⁽ⁱ⁾:=[q⁽ⁱ⁾,t̅⁽ⁱ⁾,ŵ⁽ⁱ⁾].

Given the vector x⁽ⁱ⁾, a radio agent u computes a radio allocation policy r⁽ⁱ⁾: =μ(x⁽ⁱ⁾)∈ [symbol] _{0≤r}_{⁽ⁱ⁾}_{≤1}, such that b⁽ⁱ⁾: =r⁽ⁱ⁾·b̅⁽ⁱ⁾ is the bandwidth (RB count) allowed for the final grant (b⁽ⁱ⁾≤b̅⁽ⁱ⁾).

### Step (4)

As shown in FIGS. 3 and 5, the radio allocation policy r (t) is communicated to both the corresponding DU and the AAL-B-CP through interface E3. Policy r (i) determines a final scheduling grant:

g⁽ⁱ⁾:=[q⁽ⁱ⁾,m⁽ⁱ⁾,t⁽ⁱ⁾].

that can be allocated to the UE, where t⁽ⁱ⁾≤t̅⁽ⁱ⁾ is the corresponding TB size (bits). The DU can now notify the grant g⁽ⁱ⁾ to the UE in a DCI message as specified by 3GPP.

### Step (5)

A compute resource model vₙ of each LPU n∈ [symbol] is then used to estimate the time

$${\hat{d}}_{n}^{( i )}$$

and energy

$${\hat{e}}_{n}^{( i )}$$

required by the LPU to FEC-process the TB associated with grant g⁽ⁱ⁾, i.e., and energy

$${v}_{n} ( {g}^{( i )} ) = \{ {\hat{d}}_{n}^{( i )} , {\hat{e}}_{n}^{( i )} \} .$$

Because these are stateless models, they can be built with simple neural networks trained offline for each HA.

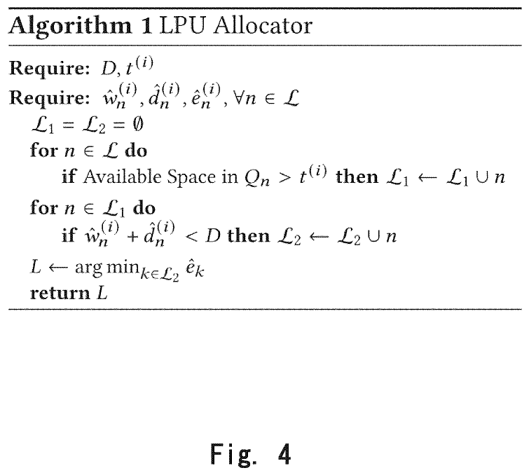

As depicted in FIGS. 3 and 5, the LPU allocation function pre-assigns an LPU to the TB associated with grant g⁽ⁱ⁾ based on a simple algorithm (described in FIG. 4). In short, the LPU allocation function prunes from the set of LPUs [symbol] those AAL LPUs that do not have the bit-capacity to store the TB, which yields a (sub)set of LPUs [symbol] ₁⊆ [symbol] . Then, using the waiting and processing time estimates

$${\hat{w}}_{n}^{( i )} and {\hat{d}}_{n}^{( i )}$$

computed above, the allocator prunes from the (sub)set [symbol] ₁ those LPUs with an expected processing time

$${\hat{w}}_{n}^{( i )} + {\hat{d}}_{n}^{( i )} > D ,$$

which yields a ‘shortlist’ (sub)set of LPUs [symbol] ₂⊆ [symbol] ₁. Then, given the shortlist [symbol] ₂, the one LPU k∈ [symbol] ₂ that can process the TB with the least amount of expected energy

$${\hat{e}}_{k}^{( i )}$$

is selected. This simple ‘greedy’ approach is both efficient and extremely fast. The TB's priority information p⁽ⁱ⁾ can also be used when selecting the LPU.

If no HA can process the grant in time, permission for that DU, to issue that scheduling grant, is rejected.

### Step (6)

After a time equal to K2 (specified by 3GPP), the UE wirelessly transmits the TB corresponding to the scheduled grant g⁽ⁱ⁾ in a PUSCH. Once received, the DU forwards the TB to the AAL-B-UP's dispatcher, which simply routes the data to the pre-assigned AAL Queue for FEC processing. Once the corresponding LPU completes the task, the decoded data is sent back to the DU for further 3GPP-standard processing (e.g., cyclic redundancy check (CRC) verification), the AAL-B-CP updates its Queue state information, and the LPU begins processing the next TB in the Queue.

### SUMMARY

Beneficially, the above described aspects include, although they are not limited to, one or more of the following:

A method that, based on predictions on processing latency and energy consumption of each hardware accelerator in a pool of heterogeneous hardware accelerators, provides compute-aware radio scheduling policies, and an LPU (Logical Processing Unit) allocator that assigns hardware accelerators to each radio scheduling grant jointly to maximize throughput and minimize energy consumption in real time.

In order to provide the above functionalities, the present document describes the following exemplary steps comprising:
1) Prior to scheduling a final grant, the DU issues a request to an RT-RIC state processor with a temporary grant.
2) A state processor that uses that information and waiting estimates from the AAL broker to build a state feature vector.
3) A radio agent that uses such state feature vector to propose a radio resource policy, which consists of a restriction (or not) on the amount of bandwidth the DU may use for a final grant.
4) A set of compute resource models that uses the radio policy and information about the grant to predict the processing latency and energy consumption of each hardware accelerator.
5) An LPU allocator that uses the predictions in step 4 to pre-assign an AAL Queue/LPU (a hardware accelerator) to the scheduled grant.
6) When the TB arrives (after a time K2 when radio grants were signalled to UEs as per 3GPP specification), the AAL-B-UP redirects the encoded TB to the pre-assigned AAL Queue/LPU.

It can be seen that the above functionalities contribute to maximizing network throughput in a shared O-Cloud system with minimum energy consumption.

### System Overview

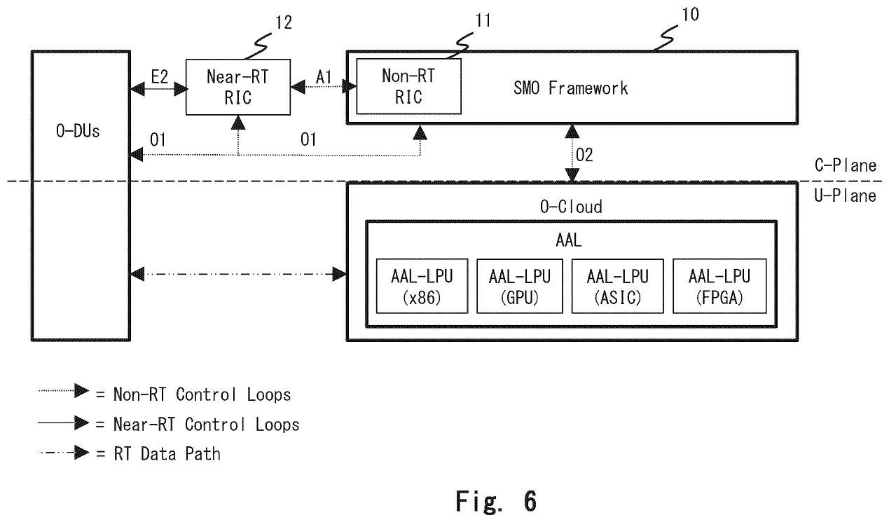

FIG. 6 schematically illustrates an O-RAN architecture to which the above aspects are applicable.

This architecture comprises the functional components: Non-RT RIC 11 and the near-RT RIC 12. While the former is hosted by the SMO framework 10 of the system (e.g., integrated within ONAP), the latter may be co-located with 3GPP gNB functions (O-CU and/or O-DU) or in a separate node as long as latency constraints are respected. FIG. 6 also depicts the O-Cloud, an O-RAN compliant cloud platform that uses hardware acceleration addons when needed and a software stack that is decoupled from the hardware to deploy eNBs/gNBs as virtualized network functions in v(R)AN scenarios.

O-RAN enables radio resource management (RRM) from a Near-RT RIC 12 through the E2 open interface, as shown in FIG. 6. E2 nodes are 3GPP-defined RAN NFs such as DUs. On the one hand, the O2 interface is used by the SMO 10 to provide non-RT infrastructure and NF lifecycle management procedures in a virtualization environment known as O-Cloud.

The SMO 10 has various organisation and management services, which may go beyond pure RAN management such as 3GPP (NG-)core management or end-to-end network slice management. In the context of O-RAN, the main responsibilities of the SMO 10 include: fault, configuration, accounting, performance, and security (FCAPS) interface to O-RAN network functions; large-timescale RAN optimization; and O-Cloud management and orchestration via the O2 interface, including resource discovery, scaling, FCAPS, software management, and interacting with O-Cloud resources.

The non-RT RIC 11 is a logical function that enables non-real-time control and optimization of RAN elements and resources, AI/ML workflow including model training and updates, and policy-based guidance of applications/features in near-RT RIC 12. The Non-RT RIC 11 also provides the A1 interface to the Near-RT RIC 12. Its main goal is to support large timescale RAN optimization (seconds or minutes), including policy computation, ML model management, and other radio resource management functions within this timescale. Data management tasks requested by the Non-RT RIC 11 should be converted into the O1/O2 interface; and contextual/enrichment information can be provided to the Near-RT RIC 12 via the A1 interface.

The Near-RT RIC 12 is a logical function in charge of (i) exposing E2 node data (network measurements, context information, etc.); (ii) implement 3GPP-defined RRM procedures; and (iii) deploy radio control policies into E2 nodes. Further, the Near-RT RIC 12 enables near-real-time optimization and control and data monitoring of O-CU and O-DU nodes and resources in near-RT timescales (between 10 ms and 1 s) via fine-grained data collection and actions over the E2 interface. Near-RT RIC 12 control is steered by the policies and assisted by models computed/trained by the non-RT RIC 11. Near-RT RIC 12 also supports xApps (independent software plug-ins to the Near-RT RIC 12 platform to provide functional extensibility to the RAN by third parties).

This architecture inherently provides three independent control loops:
Non-RT RIC 11 control loop: Large-timescale operation on the order of seconds or minutes. The goal is to perform O-RAN-specific orchestration decisions such as policy configuration or ML model training.
Near-RT RIC 12 control loop: Sub-second time-scale operation. The goal is performing tasks such as policy enforcement or radio resource management operations.
O-DU scheduler control loop: Real-time operation performing legacy radio operations such as HARQ, beamforming, or scheduling.

It will be appreciated that whilst the control loops are understood to be independent, they may still interact with each other.

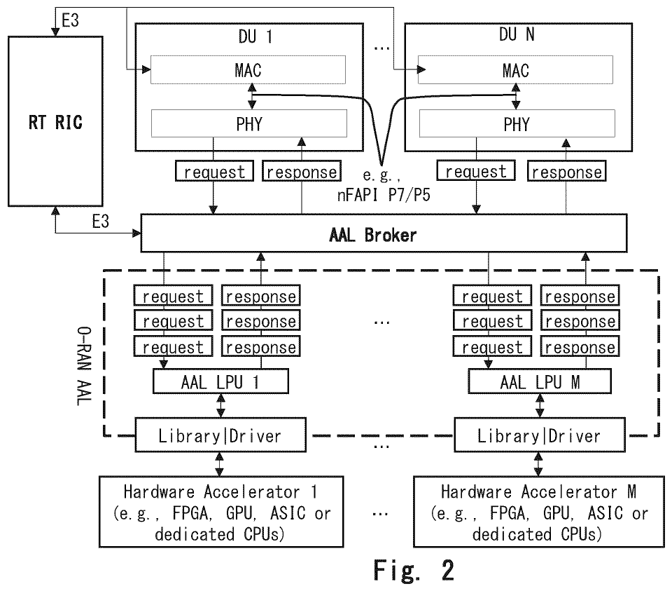

Moreover, while not visible in FIG. 6, the O-RAN architecture has been enhanced, in accordance with the previous proposals, to include an RT-RIC, an AAL Broker and the so-called ‘E3’ interface between the Broker, RT-RIC and O-DUs (as illustrated in FIGS. 2 and 3). These enhancements integrate seamlessly into the standard O-RAN O-Cloud architecture illustrated in FIG. 6.

The RT-RIC receives temporary grants issued by DUs and returns final grants (which may represent modification (or not) of the temporary grants) and thus maximize wireless throughput and allow the AAL to meet the deadline to process the corresponding TBs.

The AAL Broker has two sub-components: AAL Broker Control Plane (AAL-B-CP) and AAL Broker User Plane (AAL-B-UP). The AAL-B-CP is responsible for assigning LPUs to final grants such that processing deadlines are met with the minimum amount of energy cost. The AAL Broker User Plane (AAL-B-UP) acts as a proxy between O-RAN NFs (O-DUs, in this case) and an O-RAN AAL. From the perspective of the NFs, the AAL-B-UP behaves as a virtual AAL LPU that provides all the AAL Profiles supported by all the HAs in the system. From the perspective of each O-RAN AAL LPU, the AAL-B-UP simply plays the role of an NF. The AAL-B-UP is responsible for routing TBs granted to UEs to the AAL Queue corresponding to the LPU assigned by the AAL-B-CP. The E3 interface is an interface for real-time communication between the AAL broker, RT-RIC and O-DUs.

The components of this architecture are configured to perform one or more of the above described solutions.

### User Equipment (UE)

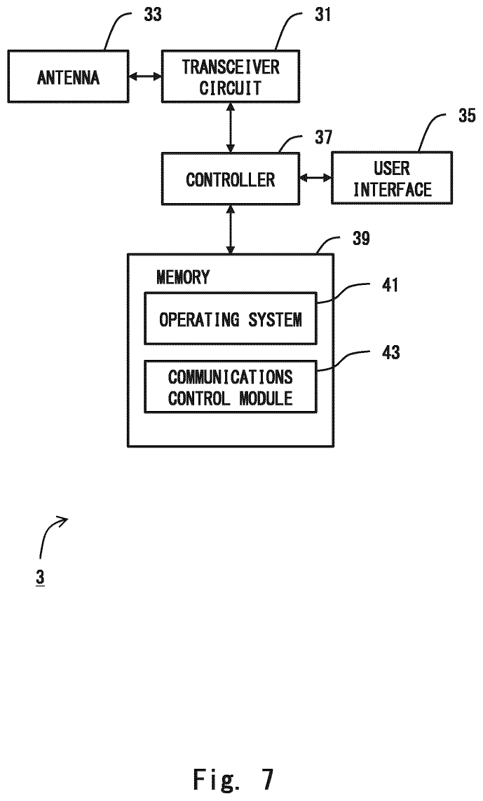

FIG. 7 is a block diagram illustrating the main components of a UE (mobile device 3) that communicates with the system shown in FIG. 6. As shown, the UE includes a transceiver circuit 31 which is operable to transmit signals to and to receive signals from the connected node(s) via one or more antenna 33. Although not necessarily shown in FIG. 7, the UE will of course have all the usual functionality of a conventional mobile device (such as a user interface 35) and this may be provided by any one or any combination of hardware, software and firmware, as appropriate. A controller 37 controls the operation of the UE in accordance with software stored in a memory 39. The software may be pre-installed in the memory 39 and/or may be downloaded via the telecommunication network 1 or from a removable data storage device (RMD), for example. The software includes, among other things, an operating system 41 and a communications control module 43. The communications control module 43 is responsible for handling (generating/sending/receiving) signalling messages and uplink/downlink data packets between the UE 3 and other nodes, including v(R)AN nodes 5, application functions, and core network nodes. Such signaling includes appropriately formatted requests and responses relating to AI&ML model training, verification, registration and deployment.

Virtual RAN (v(R)AN) Node

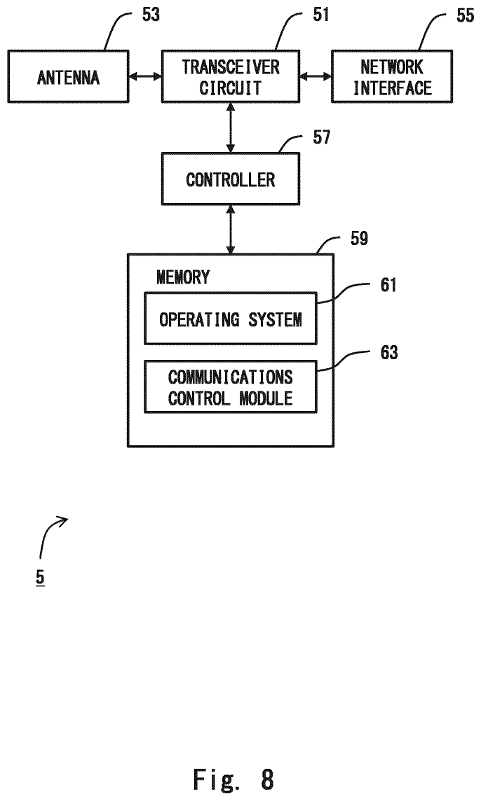

FIG. 8 is a block diagram illustrating the main virtual components of an exemplary v(R)AN node 5 (base station) that can be used in the system shown in FIG. 6. As shown, the v(R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as NG-U/NG-C). A controller 57 controls the operation of the v(R)AN node 5 in accordance with software stored in a memory 59. The software may be pre-installed in the memory 59 and/or may be downloaded via the telecommunication network 1 or from a removable data storage device (RMD), for example. The software includes, among other things, an operating system 61 and a communications control module 63. The communications control module 63 is responsible for handling (generating/sending/receiving) signalling between the v(R)AN node 5 and other nodes, such as the UE 3, and the core network nodes.

### Core Network Node

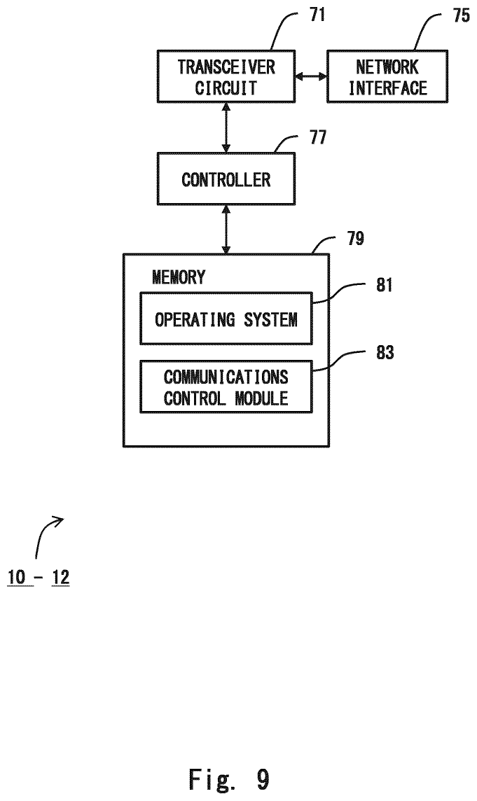

FIG. 9 is a block diagram illustrating the main virtual components of a generic core network node (or function) that can be used in the system shown in FIG. 6. As shown, the core network node includes a transceiver circuit 71 which is operable to transmit signals to and to receive signals from other nodes (including the UE 3 and the v(R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/receiving) signalling between the core network node and other nodes, such as the UE 3, v(R)AN node 5, and other core network nodes. Such signaling includes appropriately formatted requests and responses relating to Intelligent Data Collection and Management for Open RAN Intelligent Controllers.

### MODIFICATIONS AND ALTERNATIVES

Detailed aspects have been described above. As those skilled in the art will appreciate, a number of modifications and alternatives can be made to the above aspects whilst still benefiting from the inventions embodied therein. By way of illustration only a number of these alternatives and modifications will now be described.

In the above description, the UE, the v(R)AN node, and the core network node are described for ease of understanding as having a number of discrete modules (such as the communication control modules). Whilst these modules may be provided in this way for certain applications, for example where an existing system has been modified to implement the above aspects, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE, the v(R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the v(R)AN node, and the core network node in order to update their functionalities.

The above aspects are also applicable to ‘non-mobile’ or generally stationary user equipment.

Various other modifications will be apparent to those skilled in the art and will not be described in further detail here.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method of assigning hardware accelerator (HA) resources, to a scheduled grant, for processing a transport block (TB), the method comprising:
assigning a logical processing unit (LPU), of a plurality of LPUs to the scheduled grant,
wherein each LPU of the plurality of LPUs represents a respective HA, and
wherein the assigning assigns the LPU based on at least one of:
a respective latency predicted for each HA to complete processing of the TB; or
a respective energy consumption predicted for each HA to complete processing of the TB.

2. The method according to claim 1, wherein the assigning assigns the LPU by identifying a capacity based set of LPUs, including at least a subset of the plurality of LPUs, based on a respective capacity of each LPU to store the TB, and assigns the LPU from the capacity based set of LPUs.

3. The method according to claim 2, wherein each LPU included in the capacity based set of LPUs has a respective capacity that is sufficient to store the TB.

4. The method according to claim 1, wherein the assigning assigns the LPU by identifying a latency based set of LPUs, including at least a subset of the plurality of LPUs, based on the respective latency predicted for each HA, and assigns the LPU from the latency based set of LPUs.

5. The method according to claim 4, wherein the respective latency predicted for each HA is based on a combination of a predicted waiting time before processing of the TB will commence at that HA, and a predicted processing time for that HA to process the TB.

6. The method according to claim 5, wherein the predicted waiting time is based on an aggregation of a respective expected processing time of each grant in a queue associated with the LPU representing that HA, and a respective expected remaining processing time for each TB associated with each grant in the queue.

7. The method according to claim 5, wherein the predicted waiting time is based on state information, collected by a real-time radio access network intelligent controller, about each queue of a plurality of queues associated with the plurality of LPUs.

8. The method according to claim 4, wherein the latency based set of LPUs includes LPUs for which the predicted latency is no more than a predefined time constraint (D).

9. The method according to claim 1, wherein the assigning assigns the LPU by comparing the respective energy consumption predicted for each HA associated with at least a subset of the plurality of LPUs, and assigns the LPU corresponding to the HA for which a predicted energy consumption is lowest to the scheduled grant.

10. The method according to claim 1, wherein the assigning assigns the LPU based on a priority associated with the TB.

11. The method according to claim 1, wherein the assigning includes assigning a queue corresponding to the assigned LPU to the scheduled grant.

12. An apparatus for assigning hardware accelerator (HA) resources, to a scheduled grant, for processing a transport block (TB), the apparatus comprising:
processing circuitry configured to:
assign a logical processing unit (LPU) of a plurality of LPUs to the scheduled grant,
wherein each LPU of the plurality of LPUs represents a respective HA, and
wherein the assigning assigns the LPU based on at least one of:
a respective latency predicted for each HA to complete processing of the TB; or
a respective energy consumption predicted for each HA to complete processing of the TB.
